(19) United States
(12) Patent Application Publication
(10) Pub. No.: US 2016/0283789 A1
(43) Pub. Date: Sep. 29, 2016

(54) POWER-SAVING ILLUMINATION FOR IRIS AUTHENTICATION

(71) Applicant: Motorola Mobility LLC, Chicago, IL (US)

(72) Inventors: Jiri Slaby, Buffalo Grove, IL (US); Rachid M. Alameh, Crystal Lake, IL (US); Lawrence A. Willis, Dubuque, IA (US)

(21) Appl. No.: 14/667,725

(22) Filed: Mar. 25, 2015

(51) Int. Cl. G06K 9/00; H04N 5/232; H04N 5/225; H04N 5/33

(52) U.S. Cl. CPC G06K 9/00604; H04N 5/33; H04N 5/23241; H04N 5/2256

(57) ABSTRACT

In embodiments of power-saving illumination for iris authentication, a mobile device includes near infra-red lights that cycle sequentially to illuminate a face of a user of the mobile device. An eye location module can determine a position of the face of the user with respect to the mobile device based on sequential reflections of the near infra-red lights from the face of the user. The determined position also includes a distance of the face of the user from the mobile device as derived based on one of the near infra-red lights. The eye location module can then initiate illumination of an eye of the user with a subset of the near infra-red lights for a power-saving illumination based on the determined position of the face of the user with respect to the mobile device. An imager can then capture an image of the eye of the user for iris authentication.

### BACKGROUND

Portable devices, such as mobile phones, tablet devices, digital cameras, and other types of computing and electronic devices can typically run low on battery power, particularly when a device is utilized extensively between battery charges and device features unnecessarily drain battery power. For example, some devices may be designed for various types of user authentication methods to verify that a user is likely the owner of the device, such as by entering a PIN (personal identification number), or by fingerprint recognition, voice recognition, face recognition, heartrate, and/or with an iris authentication system to authenticate the user. Iris recognition is a form of biometric identification that uses pattern-recognition of one or both irises of the eyes of the user. Individuals have complex, random, iris patterns that are unique and can be imaged from a distance for comparison and authentication.

However, some of the authentication methods utilize the battery power of a device, and some may unnecessarily drain the battery power. For example, an iris authentication system may activate to illuminate the face of a user, and an imager activates to capture an image of the eyes of the user, even when the device is not properly orientated or aimed for useful illumination and imaging. Iris acquisition and subsequent authentication performance can differ depending on the eye illumination quality. Further, an iris authentication system has relatively high power requirements due to near infra-red (NIR) LED and imager use, yet presents advantages over the other authentication methods, such as security level, accuracy, potential for seamless use, and use in many environments (e.g., cold, darkness, bright sunlight, rain, etc.). Iris acquisition and authentication utilizes reflected near infra-red (NIR) light (e.g., from LEDs) to locate an eye of a user and then image the iris of the eye. The NIR illumination is used to image the iris of an eye, but this activity utilizes device battery power to generate the NIR illumination, capture an image of the iris, and compare the captured image for user authentication.

### BRIEF DESCRIPTION OF THE DRAWINGS

Embodiments of presence detection and power-saving illumination are described with reference to the following Figures. The same numbers may be used throughout to reference like features and components that are shown in the Figures:

FIG. 1 illustrates an example mobile device in which embodiments of presence detection and power-saving illumination can be implemented.

FIG. 2 illustrates examples of power-saving illumination for iris authentication in accordance with one or more embodiments.

FIG. 3 further illustrates examples of positioning an infra-red imager and near infra-red lights in implementations of power-saving illumination for iris authentication in accordance with one or more embodiments.

FIG. 4 illustrates examples of presence detection for gesture recognition and iris authentication in accordance with one or more embodiments.

FIG. 5 illustrates example method(s) of power-saving illumination for iris authentication in accordance with one or more embodiments.

FIG. 6 illustrates example method(s) of presence detection for gesture recognition and iris authentication in accordance with one or more embodiments.

FIG. 7 illustrates various components of an example device that can implement embodiments of presence detection and power-saving illumination.

### DETAILED DESCRIPTION

Embodiments of presence detection and power-saving illumination are described, such as for any type of mobile device that may be implemented with an infra-red (IR) processing system that is utilized for gesture recognition and/or iris authentication of a user of the mobile device. Typically, an IR system can detect the presence of a user and activate a high-power LED system and an imager to capture an image of the face of the user for iris authentication. However, activating a high-power illumination system and an imager can unnecessarily drain the battery power of a mobile device if the device is not positioned in front of the face of the user and correctly aligned for the illumination and imaging.

In aspects of power-saving illumination for iris authentication, a mobile device is implemented to determine the position of a user relative to the mobile device and initiate power-saving illumination techniques to conserve battery power of the device. For example, a user may pick-up the mobile device to read messages that are displayed on the display screen of the device. A position and distance of the face of the user from the mobile device is detected, and LED illumination power is adjusted accordingly. The orientation of the imager and one or more of the LEDs can also be adjusted based on triangulation of the distance. The IR imager can then be turned on, and one or more of the LEDs are activated to illuminate an eye (or both eyes) of the user for iris authentication.

The authentication performance can depend on the quality of the eye illumination, even if the eye is within the illumination cone from an LED. For example, LED intensity significantly decreases when the illumination is only slightly off-angle, such as having a reduction of approximately 50% LED illumination intensity when off-center of the illumination cone by only ten degrees (10°). Accordingly, having an optimal orientation of the imager and LEDs for illumination allows the eye location module to reduce the illumination intensity needed to capture an image, and battery power of the mobile device is conserved by utilizing fewer LEDs to provide the illumination for capturing an image of the eye of the user.

In implementations of power-saving illumination for iris authentication, a mobile device includes near infra-red lights (e.g., LEDs) that cycle sequentially to illuminate a face of a user of the mobile device. An eye location module can determine a position of the face of the user with respect to the mobile device based on sequential reflections of the near infra-red lights from the face of the user. The determined position also includes a distance of the user to the mobile device as derived based on one of the near infra-red lights. The eye location module can then initiate illumination of an eye of the user with a subset of the near infra-red lights for a power-saving illumination based on the determined position of the user with respect to the mobile device. The LED's illumination intensity is adjusted based on the distance per required illumination intensity at eye level (e.g., the closer to the eye and the better the LEDs are positioned, the lower illumination output is required). An imager can then capture an image of the eye of the user for iris authentication. Although described primarily for iris authentication, the techniques described herein for power-saving illumination for iris authentication are applicable for face recognition and/or authentication, as well as for other similarly-based authentication methods and systems.

In aspects of presence detection for gesture recognition and iris authentication, a mobile device is implemented to detect a presence of a user of the mobile device and ready the IR imager, which is orientated to capture an image of the face of the user. Alternatively, a mirror or other reflecting material can be orientated to reflect the image of the face of the user to the IR imager. For example, a user may approach the mobile device that is sitting on a table, and the user is detected by presence, motion, heat, and/or other proximity sensor detector. As the user approaches (e.g., within a few feet), the mobile device can initiate to authenticate the user of the mobile device by positioning the IR imager and/or a reflector (e.g., the mirror or other reflecting material) to capture an image of the face of the user.

The IR imager and/or the reflector can be driven by a single axial or bi-axial control for face and eye alignment to capture an image for gesture recognition and/or iris authentication. Similarly, one or more of the NIR lights (e.g., LEDs) can be orientated to illuminate the user, such as the face and eyes of the user to capture the image for the gesture recognition and/or iris authentication. The IR imager and the LEDs can be directed and focused as the user is approaching the mobile device by changing the orientation and/or angle of the IR imager and the LEDs. Alternatively, the reflectors that reflect the image of the user to the IR imager and reflect the lighting generated by the LEDs can be positioned as the user is approaching the mobile device by changing the orientation and/or angle of the reflectors.

In implementations of presence detection for gesture recognition and iris authentication, a mobile device is implemented to detect a presence of a user of the mobile device with a proximity sensor. An interaction module can determine a position of the user with respect to the mobile device based on the detected presence of the user, and project a type of user interaction with the mobile device based on the determined position of the user. The projected type of user interaction can be based on a mode of the mobile device, and whether the mobile device is being utilized for gesture recognition and/or iris authentication. The interaction module can position an imaging system to capture an image of a feature of the user, such as a gesture motion or an eye of the user, where the imaging system is positioned based on the projected type of user interaction with the mobile device. Although described primarily for iris authentication, the techniques described herein are for presence detection for gesture recognition and iris authentication applicable for face recognition and/or authentication, as well as for other similarly-based authentication methods and systems.

While features and concepts of presence detection and power-saving illumination can be implemented in any number of different devices, systems, environments, and/or configurations, embodiments of presence detection and power-saving illumination are described in the context of the following example devices, systems, and methods.

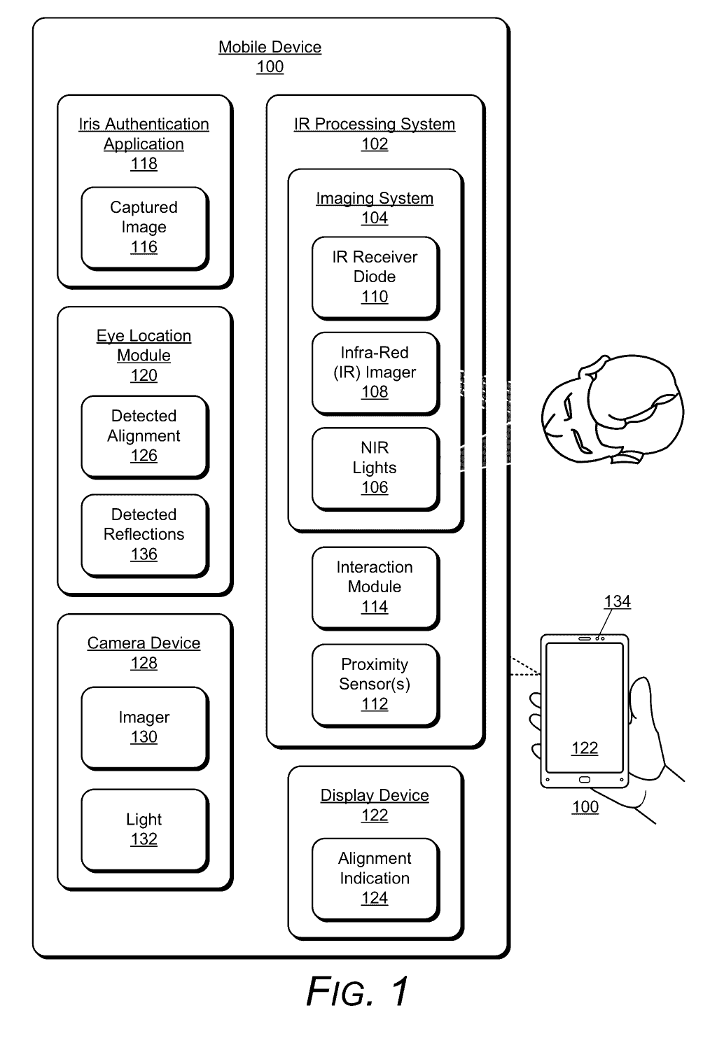

FIG. 1 illustrates an example mobile device 100 in which embodiments of presence detection and power-saving illumination can be implemented. The example mobile device 100 may be any type of mobile phone, tablet device, digital camera, or other types of computing and electronic devices that are typically battery powered. In this example, the mobile device 100 implements components and features of an infra-red (IR) processing system 102 that can be utilized for gesture recognition and/or iris authentication of a user of the mobile device. The IR processing system 102 includes an imaging system 104 with near infra-red (NIR) lights 106 (such as LEDs), an IR imager 108, and an IR receiver diode 110. Although shown as a component of the IR processing system 102 in this example, the IR imaging system 104 may be implemented in the mobile device 100 separate from the IR processing system. The IR processing system 102 can include one or more proximity sensors 112 that detect the proximity of a user to the mobile device. Additionally, the IR processing system 102 includes an interaction module 114 that is further described below with reference to features of presence detection for gesture recognition and iris authentication.

The NIR lights 106 can be implemented as a LED, or as a system of LEDs, that are used to illuminate features of a user of the mobile device 100, such as for gesture recognition and/or iris authentication, or other NIR-based systems. Generally, the LED system (e.g., of the NIR lights 106) includes one or more LEDs used to illuminate the face of the user, and from which an alignment of the face of the user with respect to the mobile device can be detected. The NIR lights 106 can be used to illuminate the eyes or other features of the user, and the IR imager 108 is dedicated for eye imaging and used to capture an image 116 of an eye (or both eyes) of the user. The captured image 116 of the eye (or eyes) can then be analyzed for iris authentication with an iris authentication application 118 implemented by the mobile device. The mobile device 100 also implements an eye location module 120 that is further described below with reference to features of power-saving illumination for iris authentication.

The interaction module 114, the iris authentication application 118, and the eye location module 120 can each be implemented as a software application or module, such as executable software instructions (e.g., computer-executable instructions) that are executable with a processing system of the device in embodiments of low-power iris authentication alignment. The interaction module 114, the iris authentication application 118, and the eye location module 120 can be stored on computer-readable storage memory (e.g., a memory device), such as any suitable memory device or electronic data storage implemented in the mobile device. Although shown as separate components, the eye location module 120 may be integrated as a module of the iris authentication application 118. Further, the iris authentication application 118 and/or the eye location module 120 may be implemented as components of the IR processing system 102.

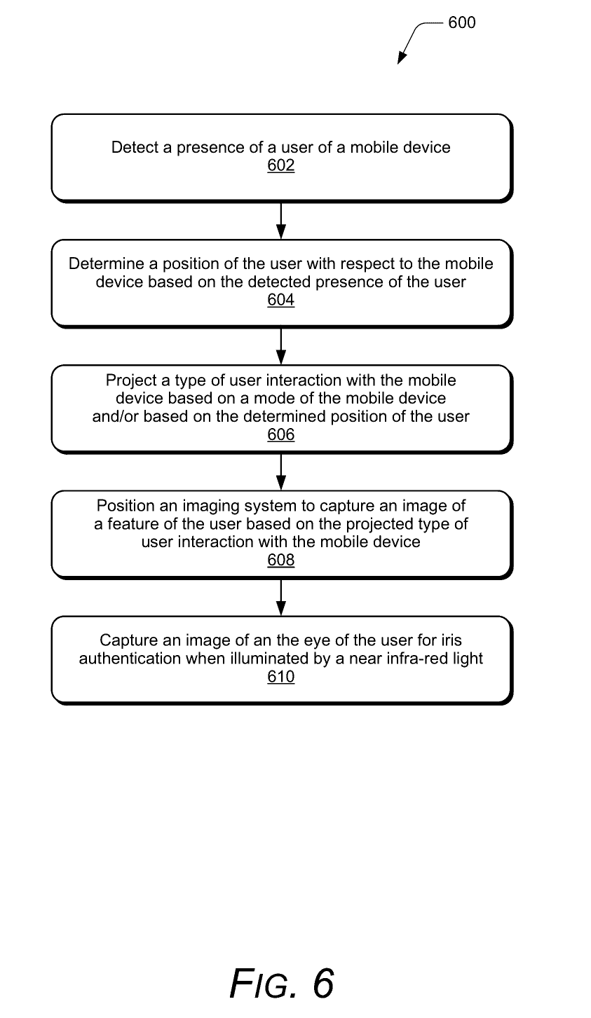

Additionally, the mobile device 100 can be implemented with various components, such as a processing system and memory, an integrated display device 122, and any number and combination of various components as further described with reference to the example device shown in FIG. 6. As further described below, the display device 122 can display an alignment indication 124, such as displayed in an interface of the IR processing system 102. The alignment indication 124 can indicate a direction to turn the device and assist a user of the mobile device 100 with achieving a correct alignment of the face of the user with respect to the mobile device so that an image of an eye (or eyes) of the user can be captured for iris authentication by the iris authentication application 118. The alignment indication 124 can be initiated and displayed based on a detected alignment 126 by the eye location module 120.

In this example, the mobile device 100 also includes a camera device 128 that is utilized to capture digital images, and the camera device 128 includes an imager 130 to capture a visible light digital image of a subject. The camera device also includes a light 132, such as a flash or LED, that emits visible light to illuminate the subject for imaging. The camera device 128 can be integrated with the mobile device 100 as a front-facing camera with a lens 134 that is integrated in the housing of the mobile device and positioned to face the user when holding the device, such as to view the display screen of the display device 122.

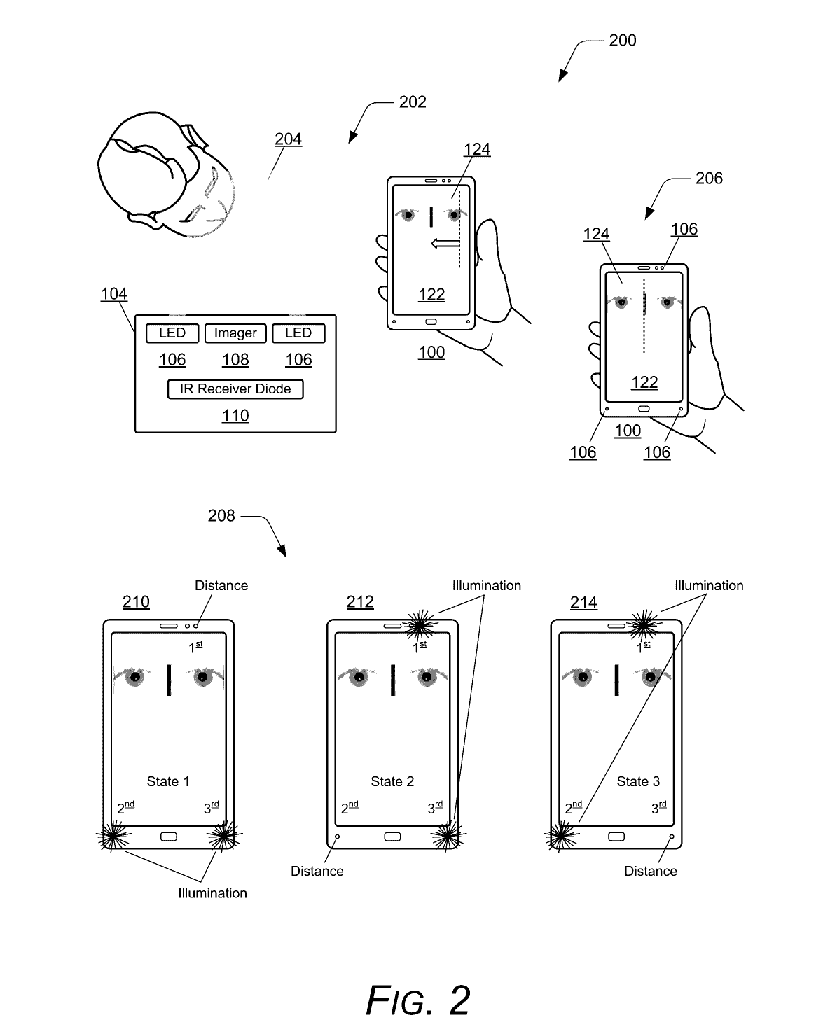

FIG. 2 illustrates examples 200 of power-saving illumination for iris authentication as described herein. As shown at 202, the imaging system 104 of the mobile device 100 includes the IR imager 108 and an LED system (e.g., of the NIR lights 106) that are used to illuminate the face of a person (e.g., a user of the mobile device 100) with near infra-red light 204. The eye location module 120 detects the alignment 126 of the face of the user with respect to the mobile device 100 based on the reflections of the LEDs (e.g., the NIR lights 106 reflected from the user). The alignment of the face of the user with respect to the mobile device can be detected by assessing an origin of the emitted lights, where two or more of the LEDs are serialized and each LED transmits in a dedicated time slot in a time-division multiple access (TDMA) system. Based on an assessment of all the reflected LED lights, the system detects whether the head of the user is in the desired viewing angle. In this current implementation, all of the LEDs can transmit the same pulse, but in different time slots. In other implementations, the LEDs are designed to each transmit a unique code (e.g., a unique LED signature).

The eye location module 120 determines the alignment 126 of the face of the user with respect to the mobile device 100 based on the detected reflections 136 of the illumination from the LEDs (e.g., the NIR lights 106 reflected from the user). Two or more of the LEDs illuminate the face of the user, and the IR receiver diode 110 receives the reflected light, from which the origins of the reflected light are assessed to determine an orientation of the head of the user. As shown at 202, the face of the user is not aligned with the imaging system 104 of the mobile device 100, and the alignment indication 124 is displayed in an interface on the display device 122 of the mobile device. Here, the alignment indication is shown as a dashed line with an arrow to direct the user which way to move the mobile device so that the dashed line is centered between the eyes as displayed in a preview of the eyes (e.g., a video preview or a still image preview).

As shown at 206, the alignment indication 124 assists the user of the mobile device 100 with achieving a correct alignment of the face of the user with respect to the device so that an image of an eye (or eyes) of the user can be captured for iris authentication by the iris authentication application 118. At 206, the alignment indication 124 that is displayed in the interface on the display device 122 shows a correct alignment of the face of the user with respect to the mobile device, and the eye location module 120 can determine the correct alignment for iris authentication based on the detected reflections 136.

In implementations, the NIR lights 106 are integrated in the housing of the mobile device 100 as shown at 206, and the lights are positioned to face the user when holding the device. As shown at 208, the NIR lights 106 cycle sequentially to illuminate the face of the user for distance detection, user position, and eye illumination. In this example, the mobile device 100 includes three NIR lights 106 and cycles sequentially through three states to illuminate the face of the user, from which the position of the user and the distance from the mobile device can be determined. If a mobile device includes more LEDs, then more states can be cycled. Further, the mobile device can implement a time-division multiplex controller to cycle the distance detection and eye illumination states in designated time slots.

In a first cycle state 210, a first LED is utilized as a basis to determine a distance from the user to the mobile device 100, and the second and third LEDs are used to illuminate the face of the user. As the device cycles to a second cycle state 212, the second LED is utilized as the basis to determine a distance from the user to the mobile device, and the first and third LEDs are used to illuminate the face of the user. As the device cycles to a third cycle state 214, the third LED is utilized as the basis to determine a distance from the user to the mobile device, and the first and second LEDs are used to illuminate the face of the user. The illumination and distance determination cycles can continue with one of the LEDs utilized for assessing the distance, while the other two LEDs are used for illumination. Alternatively or in addition, other cycle patterns of the LEDs can be utilized to determine the distance and position (e.g., angle, direction, rotation, range, etc.) of the user with respect to the device.

The IR receiver diode 110 can be utilized to receive the reflected infra-red illuminations, and based on the signature (or TDMA) of each LED reflection, the eye location module 120 can determine a position of the face of the user with respect to the mobile device 100 based on the sequential reflections of the NIR lights 106 (e.g., the LEDs). The eye location module 120 can also determine the distance from the face of the user to the mobile device as derived based on one of the LEDs (e.g., the LED that is utilized to asses distance). In addition to detecting the distance of the user to the mobile device utilizing the IR processing system 102, the distance can also be detected based on a proximity system (e.g., the proximity sensors 112) and/or iris size, as detected by pixel count (e.g., more pixels are detectable the closer the mobile device is to the user). In addition, a combination of these methods can be utilized to provide a more accurate reading, or can be selected based on contextual needs.

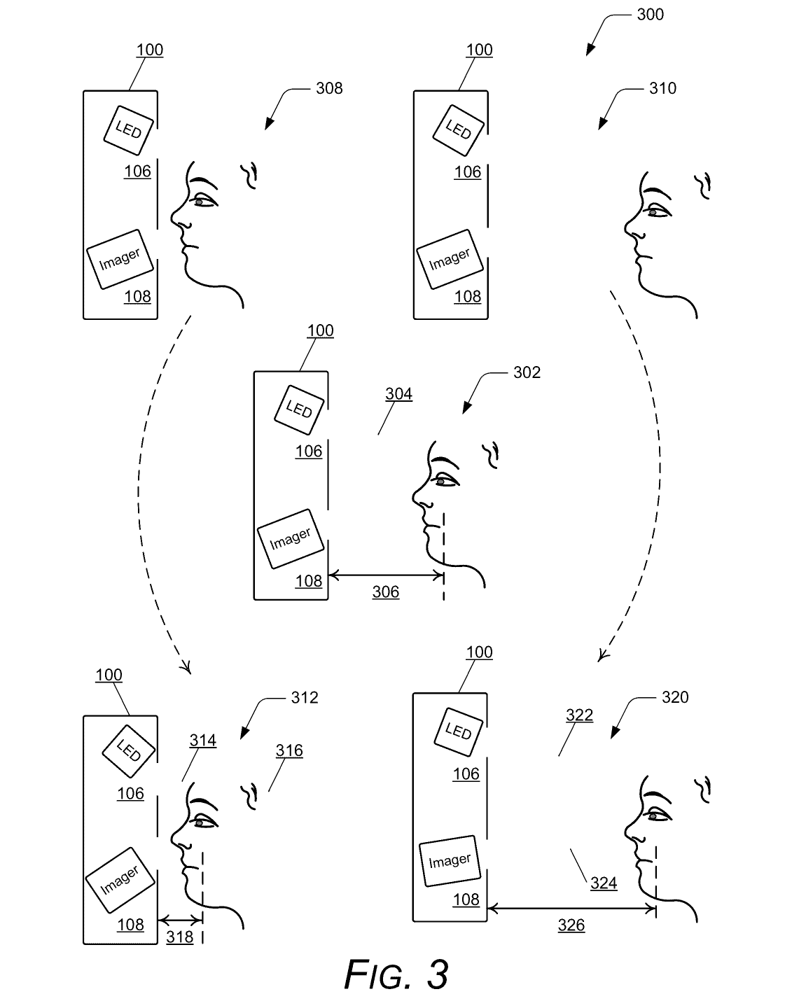

The eye location module 120 is implemented to initiate positioning the NIR lights 106 (e.g., the LEDs) to illuminate an eye (or both eyes) of the user based on the determined position of the face of the user with respect to the mobile device. The eye location module 120 also initiates positioning the IR imager 108 based on the determined position of the face of the user to capture the image 116 of the eye of the user for iris authentication by the iris authentication application 118. Positioning the IR imager and the LEDs for power-savings illumination is further described with reference to FIG. 3.

FIG. 3 illustrates examples 300 of positioning the IR imager 108 and the NIR lights 106 (e.g., the LEDs) for power-savings illumination based on the determined position of the user with respect to the mobile device 100. As shown at 302, the LED is positioned to properly project the illumination 304 and illuminate the eye (or both eyes) of the user based on the distance 306 of the user to the mobile device 100. Similarly, the IR imager 108 is positioned based on the determined position and distance 306 of the face of the user to capture the image 116 of the eye (or both eyes) of the user for iris authentication by the iris authentication application 118.

The performance of an iris authentication system changes based on the eye location (e.g., the location and/or distance) relative to the IR imager 108 and the LEDs (e.g., the NIR lights 106). Authentication performance also differs depending on the quality of the eye illumination 304, even if the eye is within the illumination cone as the light is distributed across the illumination cone from the LED. For example, LED intensity significantly decreases when the illumination is only slightly off-angle, such as a reduction of approximately 50% LED illumination intensity when off-center of the illumination cone by only ten degrees (10°). While broader viewing-angle LEDs could be used, they consume more battery power of the device. Accordingly, having an optimal orientation of the LEDs for illumination allows the eye location module 120 to reduce the illumination intensity needed to capture an image, and battery power of the mobile device is conserved by utilizing fewer NIR lights 106 to provide the illumination for capturing an image of the eye of the user.

As shown at 308, the user is too close to the mobile device 100 and the illumination and imager field-of-view converge past or beyond the eye of the user, which is ineffective to illuminate and capture an image of the eye of the user for iris authentication. Similarly, as shown at 310, the user is too far away from the mobile device 100 and the illumination and imager field-of-view converge before the eye of the user, which is also ineffective to illuminate and capture an image of the eye of the user for iris authentication.

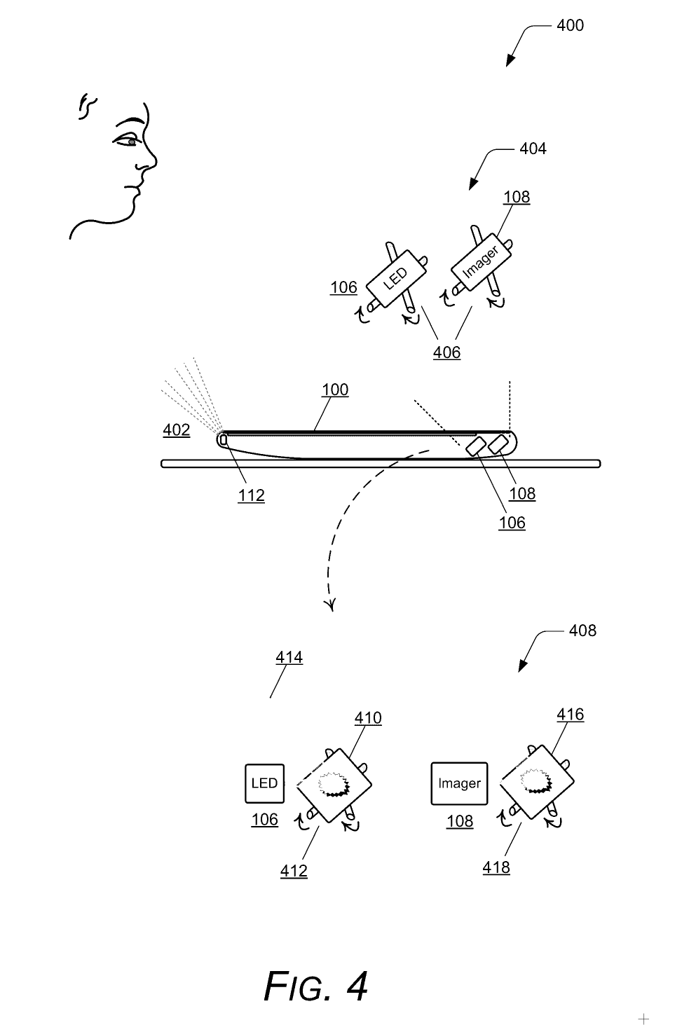

In implementations, the eye location module 120 can initiate adjusting the position of the LED light 106 and the IR imager 108 as shown at 312 to converge the illumination 314 and the imager field-of-view 316 to properly illuminate and view the eye (or both eyes) of the user based on a determined distance 318 of the user to the mobile device 100. As described in more detail with reference to FIG. 4, the LED light 106 and the IR imager 108 can be positioned using single axial or bi-axial control mechanisms. Alternatively, mirrors or other types of reflectors can be used with the single axial or bi-axial control mechanisms to direct the NIR illumination of the LED light 106, and to direct a reflection of an eye of the user to the IR imager 108. Alternatively or in addition to the eye location module 120 adjusting the position of the LED light 106 and the IR imager 108, the user may also move or reposition the device for optimal illumination to capture an image of the eye of the user for iris authentication.

Further, the eye location module 120 is implemented to initiate the illumination 314 of the eye of the user with a subset of the NIR lights 106 for a power-saving illumination based on the determined position and distance 318 of the face of the user with respect to the mobile device. In this example, the eye location module can adjust an illumination intensity of the power-saving illumination 314 by utilizing fewer NIR lights 106 due to the user being close to the mobile device 100. Additionally, the IR imager 108 and/or the IR receiver diode 110 can be utilized to measure background IR intensities, and the eye location module 120 can further adjust (e.g., increase or decrease) the illumination intensity based on the measured background IR intensities.

In this example, the eye location module 120 can also initiate adjusting the position of the LED light 106 and the IR imager 108 as shown at 320 to converge the illumination 322 and the imager field-of-view 324 to properly illuminate the eye (or both eyes) of the user based on a determined distance 326 of the user to the mobile device 100. As described above and with reference to FIG. 4, the LED light 106 and the IR imager 108 can be positioned using single axial or bi-axial control mechanisms, or reflectors can be used with the single axial or bi-axial control mechanisms to direct the NIR illumination of the LED light 106, and to direct a reflection of an eye of the user to the IR imager 108. Alternatively or in addition to adjusting the position or reflection of the LED light 106 and the IR imager 108, the user may also move or reposition the device. Further, the eye location module 120 is implemented to initiate the illumination 322 of the eye of the user with a subset of the NIR lights 106 for a power-saving illumination based on the determined position and distance 326 of the face of the user with respect to the mobile device. Although the distance 326 of the user is farther away from the mobile device 100 than the distance 318 shown at 312, power-savings are also realized by using a fewer number of the NIR lights 106, and/or by changing their illumination intensity, for the power-saving illumination 322 when the IR imager 108 and the LEDs are positioned for optimal illumination.

FIG. 4 illustrates examples 400 of presence detection for gesture recognition and iris authentication as described herein. In implementations, the interaction module 114 that is implemented by the IR processing system 102 in the mobile device 100 can receive a sensor input from one or more of the proximity sensors 112 that indicate a presence of the user of the mobile device 100 has been detected at 402, such as when the user approaches the device. The presence of the user may be detected by a presence, motion, heat, and/or other proximity sensor detector. The interaction module 114 is implemented to determine a position of the user with respect to the mobile device 100 based on the detected presence of the user, and determine an angular position of a head of the user relative to the mobile device.

When the presence of the user of the mobile device 100 has been detected, the interaction module 114 can then project a type of user interaction with the mobile device based on the determined position of the user and/or based on a mode of the mobile device, such as the mobile device being utilized for gesture recognition or iris authentication. For example, if the user is holding the mobile device 100 and the device screen is locked, the interaction module 114 can initiate the IR processing system 102 for iris authentication of an eye (or eyes) of the user to unlock the device screen. In this mode, the LEDs (e.g., the NIR lights 106) are orientated to illuminate the eye (or both eyes) of the user and the IR imager 108 is orientated to capture the image 116 for iris authentication by the iris authentication application 118.

Alternatively, if the user is holding the mobile device 100 that is unlocked and the user is interacting with the device via the display screen, then the interaction module 114 can initiate the IR processing system 102 for gesture recognition. In this mode, the LEDs (e.g., the NIR lights 106) and the IR imager 108 are orientated to detect and image user gestures, which may be detected while the device is sitting stationary or being held by the user. The mode of the mobile device 100 may be determined as any of locked, unlocked, stationary (e.g., sitting on a table as shown in this example at 400), held by the user, or as any other mode, such as may be determined using an accelerometer or other sensor.

The interaction module 114 is implemented to initiate positioning the LEDs (e.g., NIR lights 106) and/or the IR imager 108 of an imaging system 404 to capture an image of a feature of the user, where the LEDs and IR imager of the imaging system are orientated based on the projected type of user interaction with the mobile device and the detected mode of the mobile device. In this example, the LED lights 106 and the IR imager 108 can be driven by single axial or bi-axial controls 406 for face and eye alignment to capture an image for gesture recognition and/or iris authentication. One or more of the LEDs can be orientated to illuminate the user, such as the face and eyes of the user to capture the image 116 for gesture recognition and/or iris authentication. The IR imager 108 and the LED lights 106 can be directed and focused as the user is approaching the mobile device 100 by changing the orientation and/or angle of the IR imager and the LEDs.

In alternate implementations of the imaging system 404, the mobile device 100 can be implemented with an imaging system 408 that includes a reflective surface 410 (e.g., a mirror or other type of reflector), which can be driven by a single axial or bi-axial control 412 to reflect an NIR light 414 to illuminate an eye of the user, where the NIR light is reflected based on the determined position of the user with respect to the mobile device. Similarly, the imaging system 408 includes a reflective surface 416 (e.g., also a mirror or other type of reflector), which can be driven by a single axial or bi-axial control 418 to reflect an eye of the user to capture the image 116 of the eye for iris authentication, where the eye is reflected to the IR imager 108 based on the determined position of the user with respect to the mobile device. The reflector 410 can be orientated for the illumination, and the reflector 416 can be orientated for the IR imager 108 as the user is approaching the mobile device 100 by changing the orientation and/or angle of the reflectors.

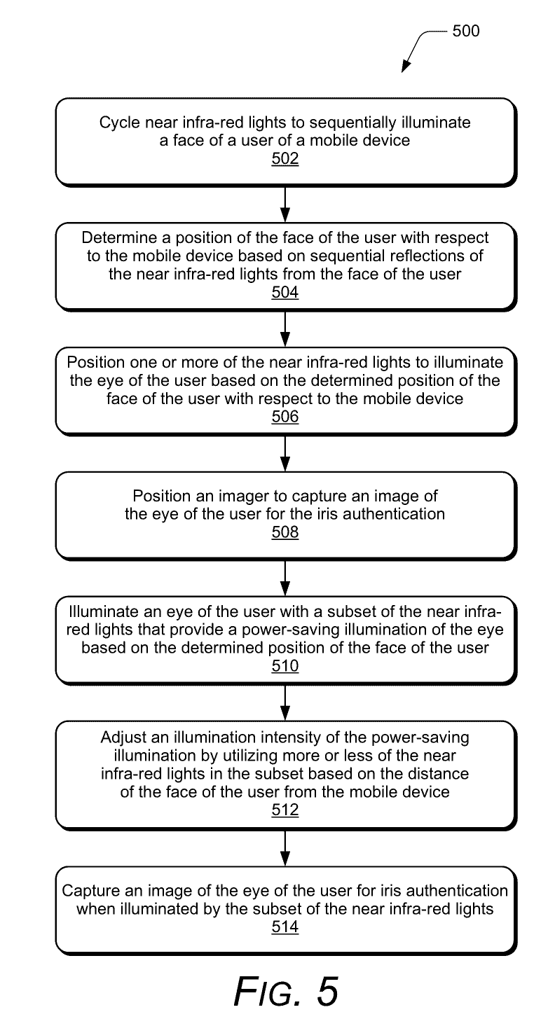

Example method 500 is described with reference to FIG. 5 in accordance with implementations of power-saving illumination for iris authentication, and example method 600 is described with reference to FIG. 6 in accordance with implementations of presence detection for gesture recognition and iris authentication. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 5 illustrates example method(s) 500 of power-saving illumination for iris authentication. The order in which the method is described is not intended to be construed as a limitation, and any number or combination of the described method operations can be performed in any order to perform a method, or an alternate method.

At 502, near infra-red lights are cycled to sequentially illuminate a face of a user of a mobile device. For example, the NIR lights 106 (e.g., LEDs) shown at 208 (FIG. 2) cycle sequentially to illuminate the face of a user of the mobile device 100 for distance detection, user position, and eye illumination. In the first cycle state 210, the first LED is utilized as a basis to determine the distance from the user to the mobile device 100, and the second and third LEDs are used to illuminate the face of the user. As the device cycles to the second cycle state 212, the second LED is utilized as the basis to determine a distance from the user to the mobile device, and the first and third LEDs are used to illuminate the face of the user. As the device cycles to the third cycle state 214, the third LED is utilized as the basis to determine a distance from the user to the mobile device, and the first and second LEDs are used to illuminate the face of the user.

At 504, a position of the face of the user is determined with respect to the mobile device based on sequential reflections of the near infra-red lights from the face of the user. For example, the eye location module 120 determines a position of the face of the user with respect to the mobile device 100 based on the sequential reflections of the NIR lights 106 (e.g., the LEDs from the user) as received by the IR receiver diode 110, and the position includes a distance 306 of the face of the user from the mobile device as derived based on one of the NIR lights.

At 506, one or more of the near infra-red lights are positioned to illuminate the eye of the user based on the determined position of the face of the user with respect to the mobile device. For example, the eye location module 120 initiates positioning the NIR lights 106 (e.g., the LEDs) to illuminate an eye (or both eyes) of the user based on the determined position of the face of the user with respect to the mobile device 100. At 508, an imager is positioned to capture an image of the eye of the user for the iris authentication. For example, the eye location module 120 also initiates positioning the IR imager 108 based on the determined position of the face of the user to capture the image 116 of the eye of the user for iris authentication by the iris authentication application 118. In implementations, the LED light 106 and the IR imager 108 are positioned using the single axial or bi-axial controls 406, as shown in FIG. 4. Alternatively, mirrors or other types of reflectors can be used with the single axial or bi-axial controls to direct the NIR illumination of the LED light 106, and to direct a reflection of an eye of the user to the IR imager 108. Alternatively or in addition to the eye location module 120 adjusting the position of the LED light 106 and the IR imager 108, the user may also move or reposition the device for optimal illumination to capture an image of the eye of the user for iris authentication.

At 510, an eye of the user is illuminated with a subset of the near infra-red lights that provide a power-saving illumination of the eye based on the determined position of the face of the user with respect to the mobile device. For example, the eye location module 120 initiates illumination of the eye of the user with a subset of the NIR lights 106 for a power-saving illumination based on the determined position and distance of the face of the user with respect to the mobile device. Having an optimal orientation of the imager and LEDs for illumination allows the eye location module 120 to reduce the illumination intensity needed to capture an image, and battery power of the mobile device is conserved by utilizing fewer NIR lights 106 to provide the illumination for capturing an image of the eye of the user.

At 512, an illumination intensity of the power-saving illumination is adjusted by utilizing more or less of the near infra-red lights in the subset based on the distance of the face of the user from the mobile device. For example, as shown at 312 (FIG. 3), the eye location module 120 adjusts the illumination intensity of the power-saving illumination 314 by utilizing fewer NIR lights for power-savings (e.g., by lowering the number of LEDs used, and/or by changing their illumination intensity) due to the user being close to the mobile device 100. Similarly, and although the distance 326 of the user as shown at 320 is farther away from the mobile device 100 than the distance 318 shown at 312, power-savings are also realized by using a fewer number of the NIR lights 106, and/or by changing their illumination intensity, for the power-saving illumination 322 when the IR imager 108 and the LEDs are positioned for optimal illumination.

At 514, an image of the eye of the user is captured for iris authentication when illuminated by the subset of the near infra-red lights. For example, the IR imager 108 captures the image 116 of the eye (or both eyes) of the user for iris authentication by the iris authentication application 118 when the eyes of the user are illuminated by the subset of the NIR lights 106.

FIG. 6 illustrates example method(s) 600 of presence detection for gesture recognition and iris authentication. The order in which the method is described is not intended to be construed as a limitation, and any number or combination of the described method operations can be performed in any order to perform a method, or an alternate method.

At 602, a presence of a user of a mobile device is detected. For example, the interaction module 114 that is implemented by the IR processing system 102 in the mobile device 100 (FIG. 1) can receive a sensor input from one or more of the proximity sensors 112 that indicate a presence of a user of the mobile device 100 has been detected at 402 (FIG. 4), such as when the user approaches the device.

At 604, a position of the user with respect to the mobile device is determined based on the detected presence of the user. For example, the interaction module 114 of the IR processing system 102 determines a position of the user with respect to the mobile device 100 based on the detected presence of the user, and determines an angular position of a head of the user relative to the mobile device. The eye location module 120 determines the alignment 126 of the face of the user with respect to the mobile device 100 based on the detected reflections 136 of the illumination from the LEDs (e.g., the NIR lights 106 reflected from the user). Two or more of the LEDs illuminate the face of the user, and the IR receiver diode 110 receives the reflected light, from which the origins of the reflected light are assessed to determine an orientation of the head of the user, and from which the position of the user can be determined.

At 606, a type of user interaction with the mobile device is projected based on a mode of the mobile device and/or the determined position of the user. For example, the interaction module 114 of the IR processing system 102 projects a type of user interaction with the mobile device 100 based on a mode of the mobile device, such as the mobile device being utilized for gesture recognition or iris authentication. The mode of the mobile device 100 may be determined as any of locked, unlocked, stationary, held by the user, or as any other mode, such as may be determined using an accelerometer or other sensor. Additionally, the IR processing system 102 may also project a type of user interaction with the mobile device 100 based on the determined position of the user (e.g., determined at 604).

At 608, an imaging system is positioned to capture an image of a feature of the user based on the projected type of user interaction with the mobile device. For example, the interaction module 114 of the IR processing system 102 in the mobile device 100 initiates positioning the LEDs (e.g., NIR lights 106) and/or the IR imager 108 of the imaging system 404 to capture an image of a feature of the user, where the LEDs and IR imager of the imaging system are orientated based on the projected type of user interaction with the mobile device and the detected mode of the mobile device. The LED lights 106 and the IR imager 108 of the imaging system 404 can be driven by single axial or bi-axial controls 406 for face and eye alignment to capture an image for gesture recognition and/or iris authentication. Alternatively, the imaging system 408 includes the reflective surface 410 (e.g., a mirror or other type of reflector) that is driven by a single axial or bi-axial control 412 to reflect the NIR light 414 to illuminate an eye (or eyes) of the user, and includes a reflective surface 416 that is driven by a single axial or bi-axial control 418 to reflect an eye of the user to capture the image 116 of the eye for iris authentication, where the NIR light is reflected to illuminate the user and the eye is reflected to the IR imager 108 based on the determined position of the user with respect to the mobile device.

At 610, an image of an the eye of the user is captured for iris authentication when illuminated by a near infra-red light. For example, the IR imager 108 captures an image of the eye (or eyes) of the user as the captured image 116 for iris authentication by the iris authentication application 118.

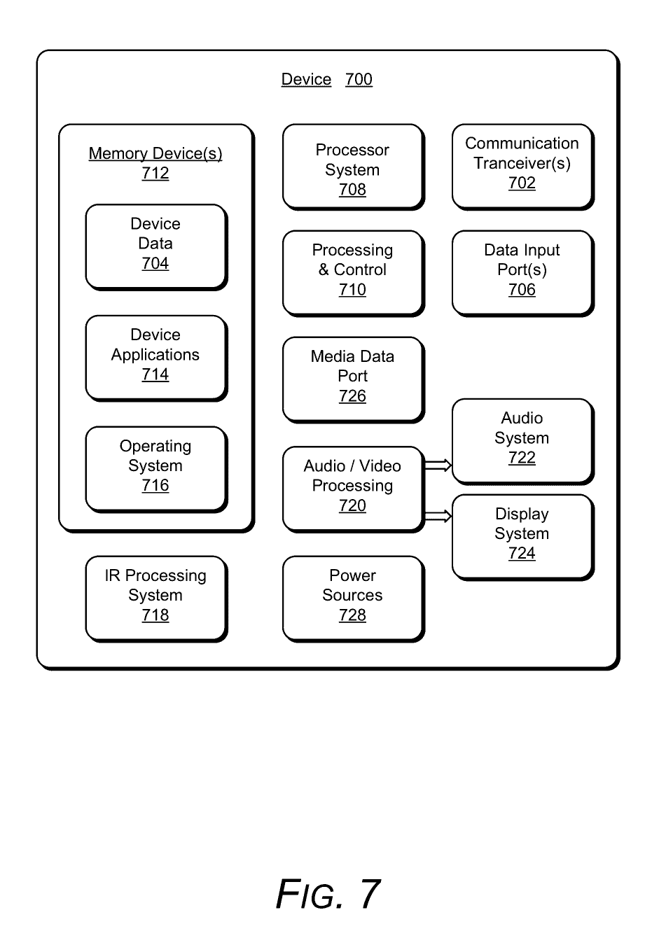

FIG. 7 illustrates various components of an example device 700 in which embodiments of presence detection and power-saving illumination can be implemented. The example device 700 can be implemented as any of the computing devices described with reference to the previous FIGS. 1-6, such as any type of client device, mobile phone, tablet, computing, communication, entertainment, gaming, media playback, and/or other type of device. For example, the mobile device 100 shown in FIG. 1 may be implemented as the example device 700.

The device 700 includes communication transceivers 702 that enable wired and/or wireless communication of device data 704 with other devices. Additionally, the device data can include any type of audio, video, and/or image data. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

The device 700 may also include one or more data input ports 706 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 700 includes a processing system 708 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 710. The device 700 may further include any type of a system bus or other data and command transfer system that couples the various components within the device. A system bus can include any one or combination of different bus structures and architectures, as well as control and data lines.

The device 700 also includes computer-readable storage memory 712 that enable data storage, such as data storage devices that can be accessed by a computing device, and that provide persistent storage of data and executable instructions (e.g., software applications, programs, functions, and the like). Examples of the computer-readable storage memory 712 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 700 may also include a mass storage media device.

The computer-readable storage memory 712 provides data storage mechanisms to store the device data 704, other types of information and/or data, and various device applications 714 (e.g., software applications). For example, an operating system 716 can be maintained as software instructions with a memory device and executed by the processing system 708. The device applications may also include a device manager, such as any form of a control application, software application, signal-processing and control module, code that is native to a particular device, a hardware abstraction layer for a particular device, and so on. In this example, the device 700 includes an IR processing system 718 that implements embodiments of presence detection and power-saving illumination, and may be implemented with hardware components and/or in software, such as when the device 700 is implemented as the mobile device 100 described with reference to FIGS. 1-6. An example of the IR processing system 718 is the IR processing system 102, which also optionally includes the iris authentication application 118 and/or the eye location module 120, that is implemented by the mobile device 100.

The device 700 also includes an audio and/or video processing system 720 that generates audio data for an audio system 722 and/or generates display data for a display system 724. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 726. In implementations, the audio system and/or the display system are integrated components of the example device. Alternatively, the audio system and/or the display system are external, peripheral components to the example device.

The device 700 can also include one or more power sources 728, such as when the device is implemented as a mobile device. The power sources may include a charging and/or power system, and can be implemented as a flexible strip battery, a rechargeable battery, a charged super-capacitor, and/or any other type of active or passive power source.

Although embodiments of presence detection and power-saving illumination have been described in language specific to features and/or methods, the subject of the appended claims is not necessarily limited to the specific features or methods described. Rather, the specific features and methods are disclosed as example implementations of presence detection and power-saving illumination, and other equivalent features and methods are intended to be within the scope of the appended claims. Further, various different embodiments are described and it is to be appreciated that each described embodiment can be implemented independently or in connection with one or more other described embodiments.

1. A method for power-saving illumination for iris authentication, the method comprising:
cycling near infra-red lights to sequentially illuminate a face of a user of a mobile device;
determining a position of the face of the user with respect to the mobile device based on sequential reflections of the near infra-red lights from the face of the user, the position including a distance of the face of the user from the mobile device as derived based on one of the near infra-red lights; and
illuminating an eye of the user with a subset of the near infra-red lights that provide a power-saving illumination of the eye based on the determined position of the face of the user with respect to the mobile device.

2. The method as recited in claim 1, further comprising:
capturing an image of the eye of the user for iris authentication when optimally illuminated by the subset of the near infra-red lights.

3. The method as recited in claim 1, further comprising:
conserving battery power of the mobile device by utilizing the subset of the near infra-red lights that provide optimal illumination for capturing an image of the eye.

4. The method as recited in claim 1, further comprising:
adjusting an illumination intensity of the power-saving illumination by utilizing more or less of the near infra-red lights in the subset.

5. The method as recited in claim 1, further comprising:
adjusting an illumination intensity of the power-saving illumination from the subset of the near infra-red lights based on the distance of the face of the user from the mobile device.

6. The method as recited in claim 1, further comprising:
positioning the subset of the near infra-red lights to illuminate the eye of the user based on the determined position of the face of the user with respect to the mobile device.

7. The method as recited in claim 1, further comprising:
positioning an imager to capture an image of the eye of the user for the iris authentication, the imager being positioned based on the determined position of the face of the user with respect to the mobile device.

8. A mobile device, comprising:
near infra-red lights configured to cycle sequentially to illuminate a face of a user of the mobile device;
a memory and processing system to implement an eye location module that is configured to:
determine a position of the face of the user with respect to the mobile device based on sequential reflections of the near infra-red lights from the face of the user, the position including a distance of the face of the user from the mobile device as derived based on one of the near infra-red lights; and
initiate illumination of an eye of the user with a subset of the near infra-red lights for a power-saving illumination based on the determined position of the face of the user with respect to the mobile device.

9. The mobile device as recited in claim 8, further comprising an imager configured to capture an image of the eye of the user for iris authentication when optimally illuminated by the subset of the near infra-red lights.

10. The mobile device as recited in claim 8, wherein battery power of the mobile device is conserved by utilizing the subset of the near infra-red lights that provide optimal illumination for capturing an image of the eye of the user.

11. The mobile device as recited in claim 8, wherein the eye location module is configured to adjust an illumination intensity of the power-saving illumination by utilizing more or less of the near infra-red lights in the subset.

12. The mobile device as recited in claim 8, wherein the eye location module is configured to adjust an illumination intensity of the power-saving illumination from the subset of the near infra-red lights based on the distance of the face of the user from the mobile device.

13. The mobile device as recited in claim 8, wherein the eye location module is configured to position the subset of the near infra-red lights to illuminate the eye of the user based on the determined position of the face of the user with respect to the mobile device.

14. The mobile device as recited in claim 8, wherein the eye location module is configured to position an imager to capture an image of the eye of the user for iris authentication, the imager being positioned based on the determined position of the face of the user with respect to the mobile device.

15. A system, comprising:
near infra-red lights configured to cycle sequentially to illuminate a face of a person;
a memory and processing system to implement an eye location module that is configured to:
determine a position of the face of the person with respect to the near infra-red lights based on sequential reflections of the near infra-red lights from the face of the person, the position including a distance to the face of the person as derived based on one of the near infra-red lights; and
initiate illumination of an eye of the person with a subset of the near infra-red lights for a power-saving illumination based on the determined position of the face of the person.

16. The system as recited in claim 15, further comprising an imager configured to capture an image of the eye of the person for iris authentication when optimally illuminated by the subset of the near infra-red lights.

17. The system as recited in claim 15, wherein the eye location module is configured to adjust an illumination intensity of the power-saving illumination by utilizing more or less of the near infra-red lights in the subset.

18. The system as recited in claim 15, wherein the eye location module is configured to adjust an illumination intensity of the power-saving illumination from the subset of the near infra-red lights based on the distance to the face of the person.

19. The system as recited in claim 15, wherein the eye location module is configured to position the subset of the near infra-red lights to illuminate the eye of the person based on the determined position of the face of the person.

20. The system as recited in claim 15, wherein the eye location module is configured to position an imager to capture an image of the eye of the person for iris authentication, the imager being positioned based on the determined position of the face of the person.
